(19) United States
(12) Patent Application Publication
(10) Pub. No.: US 2007/0009088 A1
(43) Pub. Date: Jan. 11, 2007

(54) System and method for imaging using distributed X-ray sources

(76) Inventors: Peter Michael Edic, Albany, NY (US); Bernhard Erich Hermann Claus, Niskayuna, NY (US); Jeffrey Wayne Eberhard, Albany, NY (US); James Vradenburg Miller, Clifton Park, NY (US); David Allen Langan, Clifton Park, NY (US); Mark Ernest Vermilyea, Niskayuna, NY (US); Joseph John Manak JR., Albany, NY (US); Christopher David Unger, Brookfield, WI (US)

Correspondence Address: Patrick S. Yoder;FLETCHER YODER, P.O.Box 692289, Houston, TX, 77269-2289, US

(21) Appl. No.: 11/176,418

(22) Filed: Jul. 6, 2005

(51) Int. Cl. G01N 23/04

(52) U.S. Cl. 378/62

(57) ABSTRACT

An X-ray imaging system is provided. The X-ray imaging system includes a distributed X-ray source and a detector. The distributed X-ray source is configured to emit X-rays from a plurality of emission points arranged as a substantially linear segment, a substantially arcuate segment, a curvilinear segment, or a substantially non-planar surface and the detector is configured to generate a plurality of signals in response to X-rays incident upon the detector.

### BACKGROUND

The invention relates generally to the field of non-invasive imaging, including medical imaging. In particular, the present invention relates to geometries and configurations for distributed X-ray sources and detectors useful in various imaging modalities.

X-ray imaging systems are utilized for various applications in both medical and non-medical fields. For example, medical X-ray imaging systems include general radiological, mammography, X-ray C-arm, tomosynthesis, and computed tomography imaging systems. These various imaging systems, with their different respective topologies, are used to create images or views of a patient based on the attenuation of X-rays passing through the patient. Based on the attenuation of the X-rays, the topology of the imaging system, and the type and amount of data collected, different views may be constructed, including views showing motion, contrast enhancement, volume reconstructions, two-dimensional images and so forth. Alternatively, X-ray imaging systems may also be utilized to in non-medical applications, such as in industrial quality control or in security screening of passenger luggage, packages, and/or cargo. In such applications, acquired data and/or generated images representing slices or volumes may be used to detect objects, shapes or irregularities which are otherwise hidden from casual visual inspection and which are of interest to the screener.

Typically, X-ray imaging systems, both medical and non-medical, utilize an X-ray tube to generate the X-rays used in the imaging process. In particular, conventional single, rotating-anode X-ray tubes, which are somewhat weighty and must be powered and cooled, are typically employed as a source of X-rays in X-ray based imaging systems. The size and weight of such X-ray tubes, however, may be relatively undesirable in various X-ray imaging topologies. For example, in imaging topologies where image data is acquired at different view angles relative to the imaged volume, it may be necessary to move the X-ray tube to different view angle positions relative to the object or patient. The size and weight of the X-ray tube obviously directly determines the complexity of the mechanism used to move the tube, particularly where smooth and/or rapid motion is desired. Furthermore, in topologies where the detector is moved in conjunction with the X-ray tube, the complexity of the imaging system may be further increased.

Even in systems in which the X-ray tube is generally stationary, the power and cooling requirements of the X-ray tube may result in more complicated system designs than are otherwise desirable. In particular, in certain medical imaging applications, the requisite system configurations may cause anxiousness and discomfort for the patient.

It is therefore desirable to provide improved imaging systems, topologies, and methods incorporating more compact and/or lighter X-ray sources which lighten rotational or translational loads, or even eliminate the need for rotation or translation of system components altogether. In short, it is desirable to provide an efficient imaging system that can generate high-quality images while reducing the mechanical, electrical, thermal and other challenges associated with rotation or translation of a source and/or detector.

### BRIEF DESCRIPTION

Briefly in accordance with one aspect of the technique, an X-ray imaging system is provided. The X-ray imaging system includes a distributed X-ray source and a detector. The distributed X-ray source is configured to emit X-rays from a plurality of emission points arranged as a substantially linear segment, a substantially arcuate segment, or a curvilinear segment and the detector is configured to generate a plurality of signals in response to X-rays incident upon the detector.

In accordance with another aspect of the technique, an X-ray imaging system is provided. The X-ray imaging system includes a distributed X-ray source and a detector. The distributed X-ray source is configured to emit X-rays from a plurality of emission points arranged as a substantially non-planar surface and the detector is configured to generate a plurality of signals in response to X-rays incident upon the detector.

In accordance with a further aspect of the present technique, a method is provided for acquiring X-ray image data. The method provides for emitting X-rays from a distributed X-ray source having a plurality of emission points arranged as a substantially linear segment, a substantially arcuate segment, or a curvilinear segment. The method also provides for generating a plurality of signals in response to the X-rays incident upon a detector and processing the plurality of signals to generate at least one image. Systems and computer programs that afford functionality of the type defined by this method may be provided by the present technique.

In accordance with an additional aspect of the present technique, a method is provided for acquiring X-ray image data. The method provides for emitting X-rays from a distributed X-ray source having a plurality of emission points arranged as a substantially non-planar surface. The method also provides for generating a plurality of signals in response to the X-rays incident upon a detector and processing the plurality of signals to generate at least one image. Systems and computer programs that afford functionality of the type defined by this method may be provided by the present technique.

### DRAWINGS

These and other features, aspects, and advantages of the present invention will become better understood when the following detailed description is read with reference to the accompanying drawings in which like characters represent like parts throughout the drawings, wherein:

FIG. 1 depicts an exemplary imaging system using one or more distributed sources in accordance with one aspect of the present technique;

FIG. 2 depicts an exemplary distributed source for use in the imaging system of FIG. 1;

FIG. 3 depicts a portion of a detector for use in the imaging system of FIG. 1;

FIG. 4 is a diagrammatical representation of a first exemplary imaging system configuration, including a vertical linear distributed source and a detector;

FIG. 5 is a diagrammatical representation of a further configuration, including a horizontal linear distributed source and a detector;

FIG. 6 is a diagrammatical representation of a further configuration, including a pair of arbitrarily arranged linear distributed sources and a detector;

FIG. 7 is a diagrammatical representation of a further configuration, including multiple linear distributed sources arranged as a surface relative to the plane of the detector;

FIG. 8 is a diagrammatical representation of a further configuration, including an arcuate distributed source and a detector;

FIG. 9 is a diagrammatical representation of a further configuration, including an arcuate distributed source and a linear distributed source;

FIG. 10 is a diagrammatical representation of a further configuration, including a curvilinear distributed source and a detector;

FIG. 11 is a diagrammatical representation of a further configuration, including a planar distributed source and a detector;

FIG. 12 is a diagrammatical representation of a further configuration, including a cylindrical distributed source and a detector; and

FIG. 13 is a diagrammatical representation of a further configuration, including a curviplanar distributed source and a detector.

### DETAILED DESCRIPTION

The present techniques and configurations are generally directed to X-ray imaging using distributed X-ray sources. Such imaging techniques and configurations may be useful in a variety of imaging contexts, such as medical imaging, industrial inspection systems, X-ray radiography, nondestructive testing, heavy metals analysis, security and baggage screening, and others. Though the present discussion provides examples in a medical imaging context, one of ordinary skill in the art will readily comprehend that the application of these techniques and configurations in other contexts, such as for industrial imaging, security screening, and/or baggage or package inspection, is well within the scope of the present techniques.

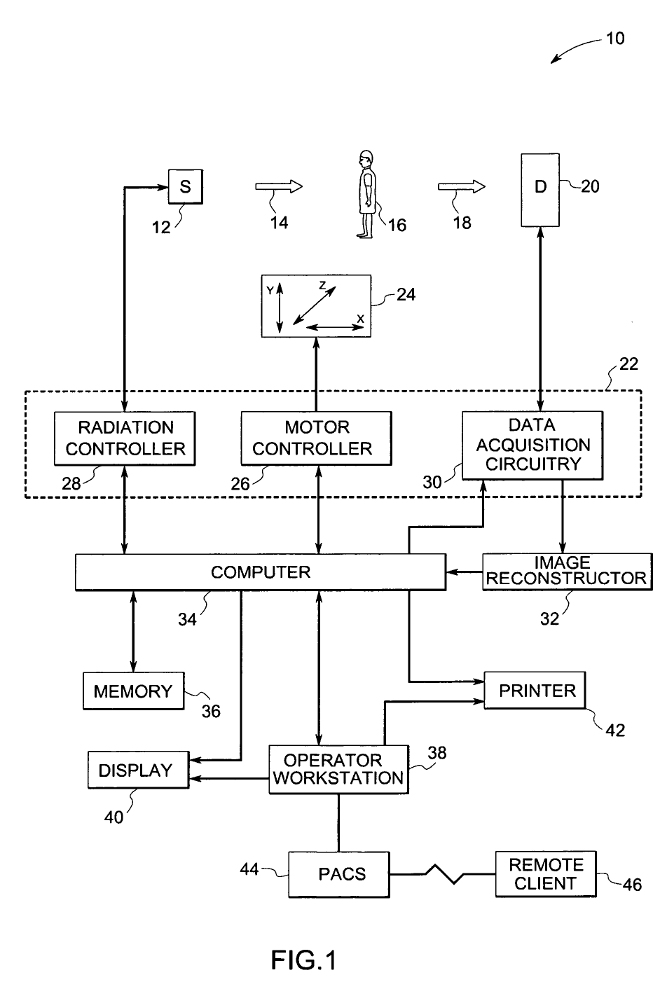

Referring now to FIG. 1, an imaging system 10 for use in accordance with the present technique is illustrated. In the illustrated embodiment, the imaging system 10 includes a radiation source 12, such as an X-ray source. In the embodiments discussed herein, the X-ray source is a distributed X-ray source consisting of two or more discrete, i.e., separated, emission points. A collimator (not shown) may be positioned adjacent to the radiation source 12. The collimator may consist of a collimating region, such as lead or tungsten shutters, for each emission point of the source 12. The collimator typically defines the size and shape of the one or more streams of radiation 14 that pass into a region in which a subject, such as a human patient 16, is positioned. An unattenuated portion of the radiation 18 passes through the subject, which provides the attenuation, and impacts a detector array, represented generally by reference numeral 20. It should be noted that portions of the X-ray beam 14 may extend beyond the boundary of the patient 16 and may impact detector 20 without being attenuated by the patient 16.

The detector 20 is generally formed by a plurality of detector elements, which detect the X-rays 18 that pass through or around the subject. For example, the detector 20 may include multiple rows and/or columns of detector elements arranged as an array. Each detector element, when impacted by an X-ray flux, produces an electrical signal that represents the integrated energy of the X-ray beam at the position of the element between subsequent signal readout of the detector 20. Typically, signals are acquired at one or more view angle positions around the subject of interest so that a plurality of radiographic views may be collected. These signals are acquired and processed to reconstruct an image of the features within the subject, as described below.

The radiation source 12 is controlled by a system controller 22, which furnishes power, focal spot location, control signals and so forth for imaging sequences. Moreover, the detector 20 is coupled to the system controller 22, which commands acquisition of the signals generated in the detector 20. The system controller 22 may also execute various signal processing and filtration functions, such as for initial adjustment of dynamic ranges, interleaving of digital image data, and so forth. In general, system controller 22 commands operation of the imaging system 10 to execute examination protocols and to process acquired data. In the present context, system controller 22 may also include signal processing circuitry, typically based upon a general purpose or application-specific digital computer, and associated memory circuitry. The associated memory circuitry may store programs and routines executed by the computer, configuration parameters, image data, and so forth. For example, the associated memory circuitry may store programs or routines for implementing the present technique.

In the embodiment illustrated in FIG. 1, system controller 22 may control the movement of a motion subsystem 24 via a motor controller 26. In the depicted imaging system 10, the motion subsystem 24 may move the X-ray source 12, the collimator 14, and/or the detector 20 in one or more directions in space with respect to the patient 16. It should be noted that the motion subsystem 24 might include a support structure, such as a C-arm or other movable arm, on which the source 12 and/or the detector 20 may be disposed. The motion subsystem 24 may further enable the patient 16, or more specifically a patient table, to be displaced with respect to the source 12 and the detector 20 to generate images of particular areas of the patient 16.

As will be appreciated by those skilled in the art, the source 12 of radiation may be controlled by a radiation controller 28 disposed within the system controller 22. The radiation controller 28 may be configured to provide power and timing signals to the radiation source 12. In addition, the radiation controller 28 may be configured to provide focal spot location, i.e., emission point activation, if the source 12 is a distributed source comprising discrete electron emitters. As described below, suitable electron emitters include tungsten filament, tungsten plate, field emitter, thermal field emitter, dispenser cathode, thermionic cathode, photo-emitter, and ferroelectric cathode.

Further, the system controller 22 may comprise a data acquisition circuitry 30. In this exemplary embodiment, the detector 20 is coupled to the system controller 22, and more particularly to the data acquisition circuitry 30. The data acquisition circuitry 30 receives data collected by readout electronics of the detector 20. In particular, the data acquisition circuitry 30 typically receives sampled analog signals from the detector 20 and converts the data to digital signals for subsequent processing by an image reconstructor 32 and/or a computer 34.

The computer 34 is typically coupled to the system controller 22. The data collected by the data acquisition circuitry 30 may be transmitted to the image reconstructor 32 and/or the computer 34 for subsequent processing and reconstruction. For example, the data collected from the detector 20 may undergo pre-processing and calibration at the data acquisition circuitry 30, the image reconstructor 32, and/or the computer 34 to condition the data to represent the line integrals of the attenuation coefficients of the scanned objects. The processed data may then be reordered, filtered, and backprojected to formulate an image of the scanned area. Although a typical filtered back-projection reconstruction algorithm is described in the present aspect, it should be noted that any suitable reconstruction algorithm may be employed, including statistical reconstruction approaches. Once reconstructed, the image produced by the imaging system 10 reveals an internal region of interest of the patient 16 which may be used for diagnosis, evaluation, and so forth.

The computer 34 may comprise or communicate with a memory 36 that can store data processed by the computer 34 or data to be processed by the computer 34. It should be understood that any type of computer accessible memory device capable of storing the desired amount of data and/or code may be utilized by such an exemplary system 10. Moreover, the memory 36 may comprise one or more memory devices, such as magnetic or optical devices, of similar or different types, which may be local and/or remote to the system 10. The memory 36 may store data, processing parameters, and/or computer programs comprising one or more routines for performing the processes described herein. Furthermore, memory 36 may be coupled directly to system controller 22 (not shown) to facilitate the storage of acquired data.

The computer 34 may also be adapted to control features enabled by the system controller 22, i.e., scanning operations and data acquisition. Furthermore, the computer 34 may be configured to receive commands and scanning parameters from an operator via an operator workstation 38 which may be equipped with a keyboard and/or other input devices. An operator may thereby control the system 10 via the operator workstation 38. Thus, the operator may observe the reconstructed image and other data relevant to the system from operator workstation 38, initiate imaging, and so forth.

A display 40 coupled to the operator workstation 38 may be utilized to observe the reconstructed image. Additionally, the scanned image may be printed by a printer 42 coupled to the operator workstation 38. The display 40 and the printer 42 may also be connected to the computer 34, either directly or via the operator workstation 38. Further, the operator workstation 38 may also be coupled to a picture archiving and communications system (PACS) 44. It should be noted that PACS 44 might be coupled to a remote system 46, such as a radiology department information system (RIS), hospital information system (HIS) or to an internal or external network, so that others at different locations may gain access to the image data.

One or more operator workstations 38 may be linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

The imaging system 10 described above may be configured in a variety of ways to improve spatial and temporal resolution, to improve image quality, and/or to improve longitudinal coverage. Indeed, various source 12 and detector 22 configurations may be implemented which improve one or more of these parameters. For example, as discussed herein, a distributed source 12 that employs multiple emission points may be employed. Activation of the emission points may be coordinated so that one or more emission points are active at a time, such as by employing an alternating activation scheme. In this manner, each emission point, when active, may provide some or all of the X-ray attenuation data required to form or reconstruct images of an object within a given field of view. In embodiments where only a subset of the projection data associated with the field of view are acquired at one time, the in-plane extent of the detector 20 may be reduced. The detector 20 may comprise elements with varying resolution, depending on the application and area of interest in the image volume. For example, for cardiac imaging, high-resolution detectors may be utilized in a region that the heart shadows, while detectors with reduced resolution may be used for the remaining portion of the imaging volume.

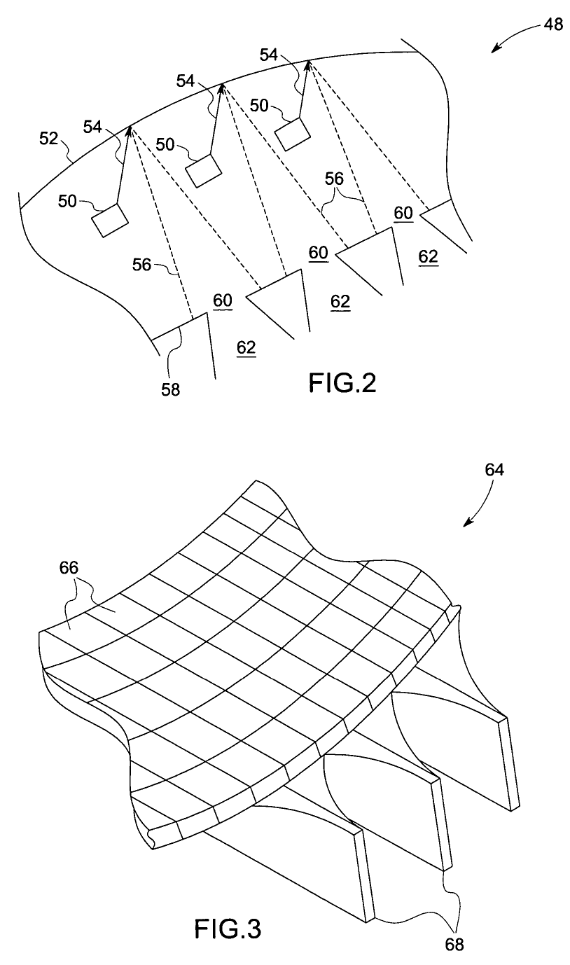

The imaging system 10 includes one or more moving or stationary distributed sources as well as one or more moving or stationary detectors for receiving radiation and processing corresponding signals to produce measurement data. FIG. 2 illustrates a portion of an exemplary distributed X-ray source 48 of the type that may be employed in the imaging system 10. As shown in FIG. 2, in an exemplary implementation, the distributed X-ray source 48 may include a series of addressable emission devices 50 housed in a vacuum housing that are coupled to radiation controller 28 shown in FIG. 1, and are triggered by the radiation controller 28 to emit electron beams during operation of the imaging system 10. The addressable emission devices 50 are positioned adjacent to a target 52 and, upon triggering by the radiation controller 28, may emit electron beams 54 toward target or anode 52. The target 52, which may, for example, be constructed of a high-density material rail, causes emission of beams of X-ray radiation, as indicated by reference numeral 56, resulting from the impinging electron beams 54. The high-density material may be, for example, tungsten or a tungsten alloy, molybdenum, tantalum or rhenium. Alternatively, high-density material may be coated at two or more places on a common rail so as to form a plurality of targets for the incoming electron beams. In reflection mode, X-rays are meant to be produced primarily on the same side of the target as where the electrons impact. In transmission mode, X-rays are produced at the opposite side of the target relative to the impinging beam of electrons. The X-ray beams 56 are directed, then, toward a collimator 58, which is generally opaque to the X-ray radiation, but which includes openings or apertures 60 that form multiple emission locations. The apertures 60 may be fixed in dimension, or may be adjustable. Apertures 60 permit a portion of the X-ray beams 56 to penetrate through the collimator to form collimated beams 62 that will be directed to the imaging volume, through the subject of interest, and that will impact detector elements.

A number of alternative configurations for emitters or distributed sources may, of course, be envisaged. Moreover, different X-ray generators in the distributed source may emit various types and shapes of X-ray beams. These may include, for example, fan-shaped beams, cone-shaped beams, and beams of various cross-sectional geometries. Similarly, the various components comprising the distributed X-ray source may also vary. In one embodiment, for example, a cold cathode emitter is envisaged which will be housed in a vacuum housing. Alternatively, the addressable emission devices 50 may be one of many available electron emission devices, for example, thermionic emitters, carbon-based emitters, photo emitters, ferroelectric emitters, laser diodes, monolithic semiconductors, etc. A stationary anode is then disposed in the housing and spaced apart from the one or more electron emitters. This type of arrangement generally corresponds to the diagrammatical illustration of FIG. 2. Other materials, configurations, and principals of operations may also be employed for the distributed source.

As discussed in greater detail below, the present techniques are based upon use of a plurality of distributed and addressable sources of X-ray radiation. Moreover, the distributed sources of radiation may be associated in single unitary enclosures or tubes or in a plurality of tubes designed to operate in cooperation. Certain of the source configurations described below may consist of substantially linear, substantially arcuate, or curvilinear segment configurations. Similarly, other sources configurations of interest may consist of substantially planar configurations or of substantially non-planar configurations, such as substantially cylindrical or curviplanar surface configurations. The individual emission points within these various configurations are addressable independently and separately so that radiation can be triggered from each of the emission points at different times during the imaging sequence as defined by the imaging protocol. Where desired, more than one such emission point may be triggered concurrently at any instant in time, or the emission points may be triggered in specific sequences to mimic two or three-dimensional motion, such as circular or helical rotation or linear or arcuate translations, or in any desired sequence around the imaging volume or plane.

As noted above, a plurality of detector elements form one or more detectors, which receive the radiation emitted by the distributed source or sources. FIG. 3 illustrates a portion of such a detector that may be employed for the present purposes. Each detector may be comprised of detector elements with varying resolution to satisfy a particular imaging application. Particular configurations for the detector or detectors are summarized below. In general, however, the detector 64 includes a series of detector elements 66 and associated signal processing units 68. These detector elements may be of one, two or more sizes, resulting in different spatial resolution characteristics for different portions of the field of view. Each detector element 66 may include an array of photodiodes and associated thin film transistors. For example, in one embodiment, X-ray radiation impacting the detectors is converted to lower energy photons by a scintillator and these photons impact the photodiodes. A charge maintained across the photodiodes is thus depleted, and the transistors may be controlled to recharge the photodiodes and thus measure the depletion of the charge. By sequentially measuring the charge depletion in the various photodiodes, each of which corresponds to a pixel in the collected data for each acquisition, data is collected that indirectly encodes radiation attenuation at each of the detector pixel locations. This data is processed by the signal processing unit 68, which will generally convert the analog depletion signals to digital values, perform any necessary processing, and transmit the acquired data to processing circuitry of the imaging system as described above.

A large number of detector elements 66 may be present in the detector so as to define many rows and columns of pixels. As described below, the detector configurations of the present technique position detector elements across from independently addressable distributed X-ray sources so as to permit data collection from one or more view angle positions for image generation or reconstruction. Although the detector is described in terms of a scintillator-based energy-integrating device, direct-conversion, photon-counting, or energy-discriminating detectors are equally suitable.

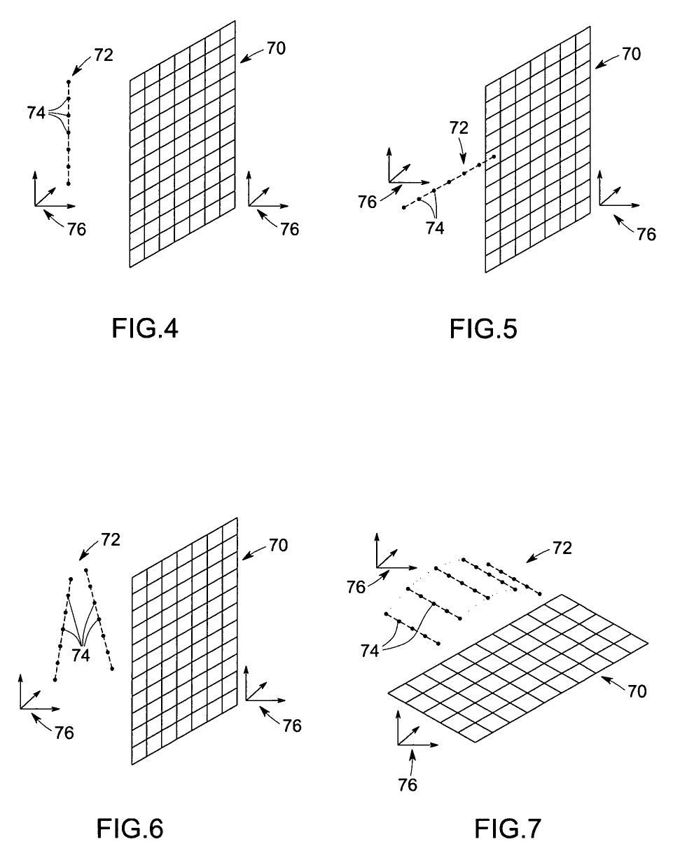

As one of ordinary skill in the art will appreciate, a variety of distributed source geometries, configurations and activation schemes may be practiced in accordance with the present technique for high-speed and efficient operation of the imaging system while significantly reducing or eliminating rotational or translational loads on the imaging system. A number of exemplary configurations and schemes for detectors and distributed sources are discussed herein as illustrated in FIGS. 4 through 13. It is to be understood, however, that the included examples do not limit the scope of the present technique. Instead, the present technique may broadly be understood to encompass any source geometries and configuration that allows for multiple, discrete emission points as well as any activation scheme for such emission points.

For example, as depicted in FIGS. 4 through 6, a detector 70 and one or more linear distributed sources 72 may be employed to acquire images of the object in the various depicted configurations. These configurations may include, but are not limited to, a vertical linear distributed source (FIG. 4), a horizontal linear distributed source (FIG. 5), two or more parallel linear distributed sources, two or more non-parallel linear distributed sources that may or may not intersect each other (FIG. 6), or two or more linear distributed sources which intersect at an arbitrary angle. The detector 70 may generally be of conventional construction, configured in a planar, cylindrical, or arbitrary topology, and including a plurality of detector elements and associated circuitry of the type described above. The distributed sources 72 may include a series of electron emitters to generate X-ray emission points 74 designed to be independently and separately addressable so as to emit X-ray radiation upon demand as described above. Both the detector 70 and the sources 72 may either be stationary or may move in a three dimensional space during operation as indicated by arrows 76.

Further, it should be noted that one or more of the linear distributed sources 72 may lie in a plane that may be generally perpendicular or otherwise non-parallel to the plane of the detectors 70, such as angled to or away from the detector 70. In yet another embodiment, multiple linear distributed sources 72 may be employed such that they form a surface relative to the plane of the detector 70, as illustrated in FIG. 7. Similarly, multiple linear distributed sources 72 may be employed in a variety of other two-dimensional and/or three-dimensional geometric arrangements while being within the scope of the present technique. These configurations may include, but are not limited to, multiple linear distributed sources 72 forming crosses, squares, rectangles, triangles, hexagons and so forth. Similarly, more complex three-dimensional arrangements, such as cones, or pyramids may also be formed by suitably arranged linear distributed sources. It should be noted that, the orientations of these configurations may be arbitrary relative to the plane of the detector 70. The distributed sources 72 used in such geometric arrangements may have a plurality of electron emitters to generate X-ray emission points 74, similar to the arrangement described above, that are independently and separately addressable so as to permit emission of X-ray radiation in specific sequences. As described above, the detectors 70 and the sources 72 may either be stationary or may move in a three-dimensional space during operation as indicated by arrows 76.

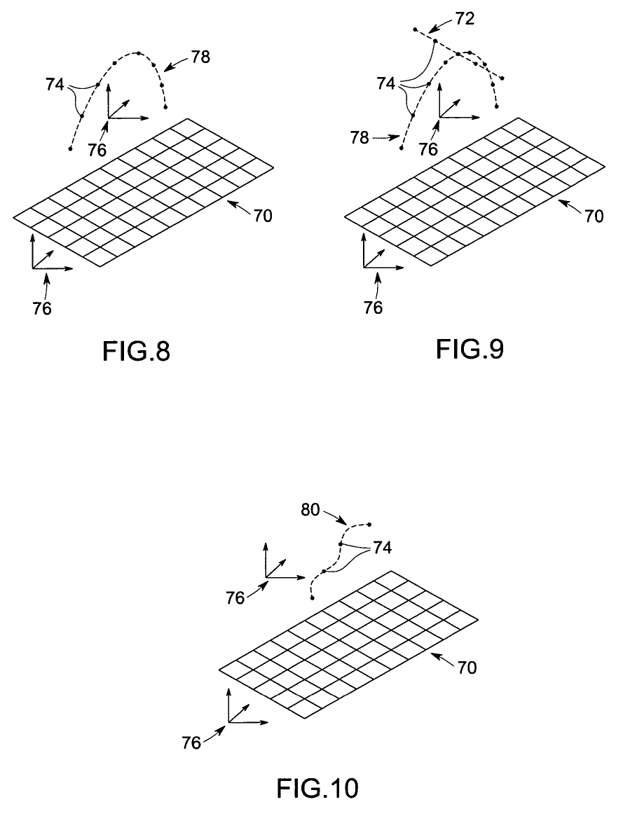

In certain embodiments, one or more arcuate distributed sources 78 and the detector 70 may be employed in a variety of configurations to acquire images of the object. For example, as illustrated in FIG. 8, an arcuate distributed source forming an arc in a plane generally perpendicular to the plane of the detector may be used for imaging the object. In other embodiments, the arcuate distributed source may be parallel to the plane of the detector or at an arbitrary angle relative to the detector. Similarly, two or more arcuate (or other) distributed sources may be employed to form various two-dimensional and three-dimensional geometric shapes, such as circles, ovals, ellipsoids, curved cross structures, and so forth. Further, multiple arcuate distributed sources 78 may be employed such that they form an arc, an inverted arc or any other surface appropriate to the imaging application relative to the plane of the detector 70. As described above, the arcuate distributed source 78 may include a plurality of independently and separately addressable emitters to generate X-ray emission points 74, such that X-ray emissions may be generated in specific sequences. The detectors 70 and the arcuate sources 78 may either be stationary or may move in a three dimensional space during operation as indicated by arrows 76. By way of further example, one or more linear 72 and arcuate 78 distributed sources may be employed in a variety of configurations to acquire images of the object as illustrated in FIG. 9. Similarly, different combinations of arcuate, linear, or other configurations of distributed sources may be combined as desired to provide the desired source configuration.

Further, the detector 70 and one or more distributed sources, where the emission points 74 form a curvilinear segment, may be employed in a variety of two-dimensional or three-dimensional configurations for imaging the objects. These configurations may vary and may include one or more curvilinear sources 80, or other sources as described herein, in configurations which may or may not be generally parallel relative to the detector plane. FIG. 10, for example, illustrates one such curvilinear distributed source 80 along with the detector 70. Here again, the detectors 70 and the curvilinear distributed sources 80 may either be stationary or may move in a three-dimensional space during operation as indicated by arrows 76.

As will be appreciated by those of ordinary skill in the art, the above distributed source types are discussed and depicted with like source types for convenience. However, combinations of the distributed source configurations disclosed herein may be implemented in various embodiments of the invention. For example, one or more linear distributed sources 72 may be configured with one or more arcuate distributed sources 78 or curvilinear distributed sources 80 in any of the various depicted embodiments employing multiple sources. In general, multi-distributed source embodiments, whether discussed herein or otherwise, may be composed of similar distributed source configurations or combinations of distributed source configurations.

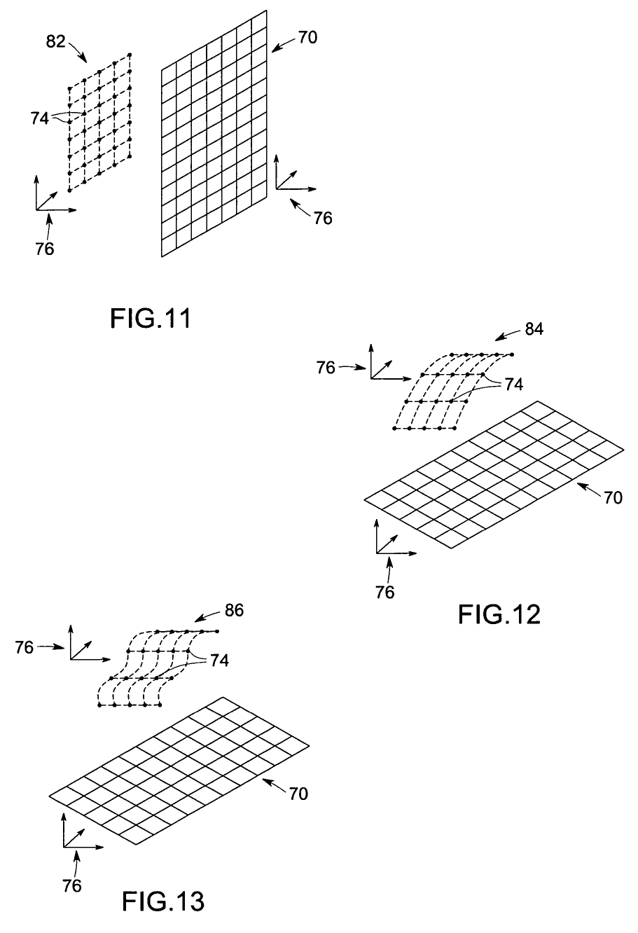

In certain embodiments, one or more distributed planar sources 82 may be employed where the X-ray emission points 74 form a two-dimensional planar surface. For example, FIG. 11 illustrates a distributed planar source 82 parallel to the plane of detector 70 wherein the source and the detector may either be stationary or may move in a three-dimensional space as indicated by arrows 76. It should be noted that, in certain embodiments, the distributed planar source 82 may be inclined relative to the plane of detector 70. Similarly, in certain embodiments, one or more distributed sources may be employed where the X-ray emission points 74 form a substantially non-planar surface. For example, as illustrated in FIG. 12, in certain embodiments, one or more distributed sources 84 may be employed where the X-ray emission points 74 form a generally cylindrical surface. Further, in certain embodiments, one or more distributed sources 86 may be employed where the X-ray emission points 74 form a generally three-dimensional surface or a curviplanar surface as illustrated in FIG. 13. It should be noted that, in the embodiments described above, the source and the detector may either be stationary or may move in a three-dimensional space as indicated by arrows 76. Furthermore, as noted above, various combinations of the planar surface, non-planar surface (such as generally cylindrical surface, generally three-dimensional surface, or curviplanar surface), linear, arcuate, and curvilinear distributed sources may be formed for use in the depicted embodiments or in other embodiments.

As will be appreciated by one skilled in the art, in embodiments employing multiple distributed sources, the various distributed sources may also move relative to each other. Additionally, movable or portable two-dimensional detector technology and/or multiple detector arrays are envisioned to facilitate the data acquisition protocols. By using distributed X-ray sources, such as sources employing thermionic or cold cathode field emission technology, physical motion of the source location and/or locations can be reduced, optimized, or omitted altogether. The distributed source technology enhances the operation of existing X-ray imaging systems for X-ray modalities, enables new applications or procedures for multiple imaging modalities, enhances image quality, and improves patient workflow.

Distributed source technology may enhance the operation of existing imaging systems for X-ray modalites in a variety of ways. For example, the various geometries, configurations and activation schemes as described in various embodiments discussed above may be employed in a wide variety of imaging systems such as a conventional mammography system, a three-dimensional mammography system, a tomosynthesis system, a general radiographic X-ray system, an X-ray C-arm system, a three-dimensional X-ray C-arm system, or a computed tomography system. The flexible and/or adaptable configurations described in various embodiments discussed above provide improved patient access and reduce overall system complexity.

Similarly, distributed source technology may enable new applications and/or procedures. For example, the configurations and methods described herein may be used in conjunction with planar imaging, axial tomographic imaging (tomosynthesis and computed tomography), as well as helical tomographic imaging (tomosynthesis and computed tomography). The motion of one or more of the distributed sources, detector, and/or patient may enable such imaging techniques in a variety of embodiments or aspects of the present technique. Further, configurations described in various embodiments discussed above result in improved registration between examinations and/or with an atlas by using intrinsic and/or non-intrinsic markers. Many imaging procedures such as diagnostic, interventional, and/or surgical procedures may be performed by the X-ray technologies and imaging system enabled by the various geometries, configurations and activation schemes described in various embodiments discussed above. These schemes enable simpler source and/or detector configurations, resulting in enhanced and/or new acquisition protocols.

In addition, distributed source technology may enhance image quality in a variety of ways. For example, system configurations employing distributed source technology, as disclosed herein, facilitate improvement in image quality by:
1. Improving the mathematical completeness of the measured data for image reconstruction (mathematical completeness of projection data refers to the ability to obtain exact reconstruction of the imaging volume, within sampling constraints, from the acquired projection data). Increased mathematical completeness of a projection data set enables improve quality in reconstructed images, as well as, a reduction in artifacts that results from missing or partial data.
2. Improving signal-to-noise ratio in measured data by implementing novel scatter reduction topologies and associated algorithms.
3. Enabling faster scan times that reduce or eliminate artifacts due to motion of a dynamic structure, such as the heart.
4. Improving image quality because gantry motion can be reduced or eliminated.
5. Enabling acquisition trajectories that are difficult to replicate with a physical system. For example, the ability to “hop” or trigger the X-Ray source between multiple angular positions during a scan so as to reduce the impact of heart motion.

Furthermore, distributed source technology, as disclosed herein, may be employed to improve patient workflow. Activation of distributed source configurations, described in various embodiments discussed above, may be programmable and/or automated based on suitable imaging protocols. The improved imaging scenarios result in better workflow and higher patient throughput. For example, in X-ray C-arm applications, the image data may be acquired by only moving the detector if the conventional X-ray tube is replaced with a stationary, distributed X-ray source. Interventional procedures are also facilitated since moving source and/or detector structures can be reduced or eliminated. This improves both patient and clinician safety. Another workflow enhancement is dose reduction to the patient. It is desirable to acquire the requisite X-ray data to allow clinicians to make a diagnosis, while minimizing X-ray dose to the patient. Image quality enhancements listed above improve the signal-to-noise ratio in X-ray measurements, thereby facilitating protocols that may reduce dose to the patient.

One example of an imaging application where multiple benefits of distributed source technology can be realized is the use of tomosynthesis for mammography. Tomographic mammography techniques based on current technology use a conventional X-ray source and high-resolution area detector to acquire multiple X-ray images of the imaging volume over a limited angular range around the breast. During the acquisition period, time is required to move the tube and allow the gantry to become stable, during which the breast remains under compression. A stationary, distributed X-ray source would allow rapid switching of source positions, improved image quality since motion is eliminated, and improved patient comfort since the scanning interval can be dramatically reduced. In one embodiment, a stationary tomographic mammography scanner could be configured to image close to the chest wall to improve detection of lesions. Similarly, an embodiment of a tomographic mammography scanner could include a distributed 2D array of source points, with each source point illuminating a small volume. In such an embodiment, if the X-ray output is sufficient, the X-ray positions in the array could be sequenced rapidly and collimated to illuminate a small volume of the breast. Furthermore, scatter would be much reduced, possibly enabling the elimination of anti-scatter grids that reduce dose efficiency. A reduction in scatter correlates to an improvement in image contrast for lesion detection. As in the application of mammography, the use of a stationary, distributed X-ray source for tomosynthesis acquisitions may allow rapid switching of source positions, improved image quality since motion is eliminated, and reduced scanning intervals. Furthermore, more sophisticated motion trajectories can be emulated using a stationary addressable source. Thus, the quality of the data from a completeness perspective can be significantly improved, leading to better image quality and fewer artifacts. Since it is possible to rapidly scan the patient using stationary, distributed source technology, dynamic tomosynthesis applications that are not currently envisioned in the clinical environment are possible. As described in this example, stationary distributed source technology simultaneously enhances the operation of the tomographic X-ray imaging system (no gantry motion), enables new procedures (i.e. dynamic imaging), enhances image quality (no gantry motion and scatter reduction), and improves patient comfort and workflow (shorter scan times).

While only certain features of the invention have been illustrated and described herein, many modifications and changes will occur to those skilled in the art. It is, therefore, to be understood that the appended claims are intended to cover all such modifications and changes as fall within the true spirit of the invention.

1. An X-ray imaging system, comprising:
one or more distributed X-ray sources, wherein the one or more distributed X-ray sources are configured to emit X-rays from a plurality of emission points arranged as a substantially non-linear segment; and
a detector configured to generate a plurality of signals in response to X-rays incident upon the detector.

2. The X-ray imaging system of claim 1, wherein the one or more distributed X-ray sources are configured to remain stationary with respect to an imaging volume.

3. The X-ray imaging system of claim 1, wherein the detector is configured to remain stationary with respect to an imaging volume.

4. The X-ray imaging system of claim 1, wherein the one or more distributed X-ray sources are configured to move with respect to an imaging volume.

5. The X-ray imaging system of claim 1, wherein the X-ray imaging system comprises a mammography system, a tomosynthesis system, a general radiographic X-ray system, an X-ray C-arm system, or a computed tomography system.

6. The X-ray imaging system of claim 1, wherein each of the one or more distributed X-ray sources comprises:
one or more addressable emission devices adapted to emit electron beams; and
one or more anodes spaced apart from the addressable emission devices for emitting X-rays at a plurality of emission points upon impingement of the electron beams.

7. The X-ray imaging system of claim 6, wherein the one or more addressable emission devices comprises thermionic emitters, cold-cathode emitters, carbon-based emitters, photo emitters, ferroelectric emitters, laser diodes, or monolithic semiconductors.

8. An X-ray imaging system, comprising:
one or more distributed X-ray sources, wherein the one or more distributed X-ray sources are configured to emit X-rays from a plurality of emission points arranged as a substantially non-planar surface; and
a detector configured to generate a plurality of signals in response to X-rays incident upon the detector.

9. The X-ray imaging system of claim 8, wherein the one or more distributed X-ray sources are configured to remain stationary with respect to an imaging volume.

10. The X-ray imaging system of claim 8, wherein the detector is configured to remain stationary with respect to an imaging volume.

11. The X-ray imaging system of claim 8, wherein the one or more distributed X-ray sources are configured to move with respect to an imaging volume.

12. The X-ray imaging system of claim 8, wherein the X-ray imaging system comprises a mammography system, a tomosynthesis system, a general radiographic X-ray system, an X-ray C-arm system, or a computed tomography system.

13. The X-ray imaging system of claim 8, wherein each of the one or more distributed X-ray sources comprises:
one or more addressable emission devices adapted to emit electron beams; and
one or more anodes spaced apart from the addressable emission devices for emitting X-rays at a plurality of emission points upon impingement of the electron beams.

14. The X-ray imaging system of claim 13, wherein the one or more addressable emission devices comprises thermionic emitters, cold-cathode emitters, carbon-based emitters, photo emitters, ferroelectric emitters, laser diodes, or monolithic semiconductors.

15. A method for acquiring X-ray image data, the method comprising:
emitting X-rays from one or more distributed X-ray sources having a plurality of emission points arranged as a substantially non-linear segment;
generating a plurality of signals in response to the X-rays incident upon a detector; and
processing the plurality of signals to generate at least one image.

16. The method of claim 15, comprising moving the one or more distributed X-ray sources relative to an imaging volume.

17. The method of claim 15, comprising moving the detector relative to an imaging volume.

18. The method of claim 15, comprising moving a patient support relative to an imaging volume.

19. The method of claim 15, wherein the distributed X-ray source is a component of a mammography system, tomosynthesis system, an X-ray C-arm system, a general radiographic X-ray system, or a computed tomography system.

20. A method for acquiring X-ray image data, the method comprising:
emitting X-rays from one or more distributed X-ray sources having a plurality of emission points arranged as a substantially non-planar surface;
generating a plurality of signals in response to the X-rays incident upon a detector; and
processing the plurality of signals to generate at least one image.

21. The method of claim 20, comprising moving the one or more distributed X-ray sources relative to an imaging volume.

22. The method of claim 20, comprising moving the detector relative to an imaging volume.

23. The method of claim 20, comprising moving a patient support relative to an imaging volume.

24. The method of claim 20, wherein the distributed X-ray source is a component of a mammography system, a tomosynthesis system, a general radiographic X-ray system, an X-ray C-arm system, or a computed tomography system.

25. The X-ray imaging system of claim 1, wherein the substantially non-linear segment comprises a substantially arcuate segment or a curvilinear segment.

26. The X-ray imaging system of claim 1, wherein the substantially non-linear segment comprises two or more substantially linear sub-segments.

27. The X-ray imaging system of claim 8, wherein the substantially non-planar surface comprises two or more substantially planar sub-surfaces.

28. An X-ray imaging system, comprising:
one or more distributed X-ray sources, wherein the one or more distributed X-ray sources are configured to emit X-rays from a plurality of emission points arranged as a substantially linear segment and are configured to move non-rotationally with respect to an imaging volume; and
a detector configured to generate a plurality of signals in response to X-rays incident upon the detector.

29. An X-ray imaging system, comprising:
one or more distributed X-ray sources, wherein the one or more distributed X-ray sources are configured to emit X-rays from a plurality of emission points arranged as a substantially non-planar surface and are configured to move non-rotationally with respect to an imaging volume; and
a detector configured to generate a plurality of signals in response to X-rays incident upon the detector.
